(19) United States
(12) Patent Application Publication
(10) Pub. No.: US 2023/0137545 A1
(43) Pub. Date: May 4, 2023

(54) DELIVERY VEHICLE, SYSTEM AND METHOD FOR MOVING STORAGE CONTAINERS BETWEEN A FIRST CONVEYOR ON THE DELIVERY VEHICLE AND AN EXTERNAL CONVEYOR

(71) Applicant: Autostore Technology AS, Nedre Vats (NO)

(72) Inventor: Trond Austrheim, Etne (NO)

(73) Assignee: Autostore Technology AS, Nedre Vats (NO)

(21) Appl. No.: 17/911,829

(22) PCT Filed: Mar. 16, 2021
(86) PCT No.: PCT/EP2021/056647

§ 371 Date: Sep. 15, 2022

(30) Foreign Application Priority Data
Mar. 24, 2020 (NO) 20200346

(51) Int. Cl. B65G 1/04; B65G 1/06; B65G 15/22; B65G 17/26; B65G 23/24

(52) U.S. Cl. CPC B65G 1/0464; B65G 1/065; B65G 15/22; B65G 17/26; B65G 23/24

(57) ABSTRACT

A delivery vehicle operates on a two-dimensional rail system with rails extending in a first direction and a second direction. The second direction is perpendicular to the first direction. The delivery vehicle includes a vehicle body; two sets of wheels connected to the vehicle body for engagement with the underlying rail system and for moving the delivery vehicle in the first and second directions; a container carrier for supporting a container from below, wherein the container carrier comprises a first conveyor; a conveyor drive shaft for driving the first conveyor; and at least one drive coupling. The at least one drive coupling includes a connection interface accessible from an outer side portion of the vehicle body. The drive coupling is rotatably connected to a motor drive shaft such that when the motor drive shaft is rotated the drive coupling and the connection interface are rotated.

### FIELD OF THE INVENTION

The invention relates to the field of automated storage and retrieval systems. In particular, the invention relates to a delivery vehicle, a system and method for moving storage containers between a first conveyor on the delivery vehicle and an external second conveyor.

### BACKGROUND AND PRIOR ART

FIG. 1A discloses a typical prior art automated storage and retrieval system 1 with a framework structure 100 and FIGS. 2 and 3 discloses two different prior art container handling vehicles 201,301 suitable for operating on such a system 1.

The framework structure 100 comprises upright members 102, horizontal members 103 and a storage volume comprising storage columns 105 arranged in rows between the upright members 102 and the horizontal members 103. In these storage columns 105 storage containers 106, also known as bins, are stacked one on top of one another to form stacks 107. The members 102, 103 may typically be made of metal, e.g. extruded aluminum profiles.

The framework structure 100 of the automated storage and retrieval system 1 comprises a rail system 108 arranged across the top of framework structure 100, on which rail system 108 a plurality of container handling vehicles 201,301 are operated to raise storage containers 106 from, and lower storage containers 106 into, the storage columns 105, and also to transport the storage containers 106 above the storage columns 105. The rail system 108 comprises a first set of parallel rails 110 arranged to guide movement of the container handling vehicles 201,301 in a first direction X across the top of the frame structure 100, and a second set of parallel rails 111 arranged perpendicular to the first set of rails 110 to guide movement of the container handling vehicles 201,301 in a second direction Y which is perpendicular to the first direction X. Containers 106 stored in the columns 105 are accessed by the container handling vehicles through access openings 112 in the rail system 108. The container handling vehicles 201,301 can move laterally above the storage columns 105, i.e. in a plane which is parallel to the horizontal X-Y plane.

The upright members 102 of the framework structure 100 may be used to guide the storage containers during raising of the containers out from and lowering of the containers into the columns 105. The stacks 107 of containers 106 are typically self-supportive.

Each prior art container handling vehicle 201,301 comprises a vehicle body 201a,301a, and first and second sets of wheels 201b,301b,201c,301c which enable the lateral movement of the container handling vehicles 201,301 in the X direction and in the Y direction, respectively. In FIGS. 2 and 3 two wheels in each set are fully visible. The first set of wheels 201b,301b is arranged to engage with two adjacent rails of the first set 110 of rails, and the second set of wheels 201c,301c is arranged to engage with two adjacent rails of the second set 111 of rails. At least one of set wheels 201b,301b,201c,301c can be lifted and lowered, so that the first set of wheels 201b,301b and/or the second set of wheels 201c,301c can be engaged with the respective set of rails 110, 111 at any one time.

Each prior art container handling vehicle 201,301 also comprises a lifting device (not shown) for vertical transportation of storage containers 106, e.g. raising a storage container 106 from, and lowering a storage container 106 into, a storage column 105. The lifting device comprises one or more gripping/engaging devices which are adapted to engage a storage container 106, and which gripping/engaging devices can be lowered from the vehicle 201,301 so that the position of the gripping/engaging devices with respect to the vehicle 201,301 can be adjusted in a third direction Z which is orthogonal the first direction X and the second direction Y. Parts of the gripping device of the container handling vehicle 301 is shown in in FIG. 3 and is indicated with reference number 304. The gripping device of the container handling device 201 is located within the vehicle body 301a in FIG. 2.

Conventionally, and also for the purpose of this application, Z=1 identifies the uppermost layer of storage containers, i.e. the layer immediately below the rail system 108, Z=2 the second layer below the rail system 108, Z=3 the third layer etc. In the exemplary prior art disclosed in FIG. 1A, Z=8 identifies the lowermost, bottom layer of storage containers. Similarly, X=1 . . . n and Y=1 . . . n identifies the position of each storage column 105 in the horizontal plane. Consequently, as an example, and using the Cartesian coordinate system X, Y, Z indicated in FIG. 1A, the storage container identified as 106′ in FIG. 1A can be said to occupy storage position X=10, Y=2, Z=3. The container handling vehicles 201,301 can be said to travel in layer Z=0, and each storage column 105 can be identified by its X and Y coordinates.

The storage volume of the framework structure 100 has often been referred to as a grid 104, where the possible storage positions within this grid is referred to as a storage cell. Each storage column may be identified by a position in an X− and Y− direction, while each storage cell may be identified by a container number in the X−, Y and Z− direction.

Each prior art container handling vehicle 201,301 comprises a storage compartment or space for receiving and stowing a storage container 106 when transporting the storage container 106 across the rail system 108. The storage space may comprise a cavity arranged centrally within the vehicle body 201a as shown in FIG. 2 and as described in e.g. WO2015/193278A1, the contents of which are incorporated herein by reference.

FIG. 3 shows an alternative configuration of a container handling vehicle 301 with a cantilever construction. Such a vehicle is described in detail in e.g. NO317366, the contents of which are also incorporated herein by reference.

The central cavity container handling vehicles 201 shown in FIG. 2 may have a footprint that covers an area with dimensions in the X and Y directions which is generally equal to the lateral extent of a storage column 105, e.g. as is described in WO2015/193278A1, the contents of which are incorporated herein by reference. The term ‘lateral’ used herein may mean ‘horizontal’.

Alternatively, the central cavity container handling vehicles 101 may have a footprint which is larger than the lateral area defined by a storage column 105, e.g. as is disclosed in WO2014/090684A1.

The rail system 108 typically comprises rails with grooves into which the wheels of the vehicles are inserted. Alternatively, the rails may comprise upwardly protruding elements, where the wheels of the vehicles comprise flanges to prevent derailing. These grooves and upwardly protruding elements are collectively known as tracks. Each rail may comprise one track, or each rail may comprise two parallel tracks (so-called “double tracks” which is described in relation to FIGS. 1B-1D below).

WO2018146304, the contents of which are incorporated herein by reference, illustrates a typical configuration of rail system 108 comprising rails and parallel tracks in both X and Y directions.

In the framework structure 100, a majority of the columns 105 are storage columns 105, i.e. columns 105 where storage containers 106 are stored in stacks 107. However, some columns 105 may have other purposes. In FIG. 1A, columns 119 and 120 are such special-purpose columns used by the container handling vehicles 201,301 to drop off and/or pick up storage containers 106 so that they can be transported to an access station (not shown) where the storage containers 106 can be accessed from outside of the framework structure 100 or transferred out of or into the framework structure 100. Within the art, such a location is normally referred to as a ‘port’ and the column in which the port is located may be referred to as a ‘port column’ 119,120. The transportation to the access station may be in any direction, that is horizontal, tilted and/or vertical. For example, the storage containers 106 may be placed in a random or dedicated column 105 within the framework structure 100, then picked up by any container handling vehicle and transported to a port column 119,120 for further transportation to an access station. Note that the term ‘tilted’ means transportation of storage containers 106 having a general transportation orientation somewhere between horizontal and vertical.

In FIG. 1A, the first port column 119 may for example be a dedicated drop-off port column where the container handling vehicles 201,301 can drop off storage containers 106 to be transported to an access or a transfer station, and the second port column 120 may be a dedicated pick-up port column where the container handling vehicles 201,301 can pick up storage containers 106 that have been transported from an access or a transfer station.

The access station may typically be a picking or a stocking station where product items are removed from or positioned into the storage containers 106. In a picking or a stocking station, the storage containers 106 are normally not removed from the automated storage and retrieval system 1, but are returned into the framework structure 100 again once accessed. A port can also be used for transferring storage containers to another storage facility (e.g. to another framework structure or to another automated storage and retrieval system), to a transport vehicle (e.g. a train or a lorry), or to a production facility.

A conveyor system comprising conveyors is normally employed to transport the storage containers between the port columns 119,120 and the access station.

If the port columns 119,120 and the access station are located at different levels, the conveyor system may comprise a lift device with a vertical component for transporting the storage containers 106 vertically between the port column 119,120 and the access station.

The conveyor system may be arranged to transfer storage containers 106 between different framework structures, e.g. as is described in WO2014/075937A1, the contents of which are incorporated herein by reference.

When a storage container 106 stored in one of the columns 105 disclosed in FIG. 1A is to be accessed, one of the container handling vehicles 201,301 is instructed to retrieve the target storage container 106 from its position and transport it to the drop-off port column 119. This operation involves moving the container handling vehicle 201,301 to a location above the storage column 105 in which the target storage container 106 is positioned, retrieving the storage container 106 from the storage column 105 using the container handling vehicle's 201,301 lifting device (not shown), and transporting the storage container 106 to the drop-off port column 119. If the target storage container 106 is located deep within a stack 107, i.e. with one or a plurality of other storage containers 106 positioned above the target storage container 106, the operation also involves temporarily moving the above-positioned storage containers prior to lifting the target storage container 106 from the storage column 105. This step, which is sometimes referred to as “digging” within the art, may be performed with the same container handling vehicle that is subsequently used for transporting the target storage container to the drop-off port column 119, or with one or a plurality of other cooperating container handling vehicles. Alternatively, or in addition, the automated storage and retrieval system 1 may have container handling vehicles specifically dedicated to the task of temporarily removing storage containers from a storage column 105. Once the target storage container 106 has been removed from the storage column 105, the temporarily removed storage containers can be repositioned into the original storage column 105. However, the removed storage containers may alternatively be relocated to other storage columns.

When a storage container 106 is to be stored in one of the columns 105, one of the container handling vehicles 201,301 is instructed to pick up the storage container 106 from the pick-up port column 120 and transport it to a location above the storage column 105 where it is to be stored. After any storage containers positioned at or above the target position within the storage column stack 107 have been removed, the container handling vehicle 201,301 positions the storage container 106 at the desired position. The removed storage containers may then be lowered back into the storage column 105, or relocated to other storage columns.

For monitoring and controlling the automated storage and retrieval system 1, e.g. monitoring and controlling the location of respective storage containers 106 within the framework structure 100, the content of each storage container 106; and the movement of the container handling vehicles 201,301 so that a desired storage container 106 can be delivered to the desired location at the desired time without the container handling vehicles 201,301 colliding with each other, the automated storage and retrieval system 1 comprises a control system 500 which typically is computerized and which typically comprises a database for keeping track of the storage containers 106.

It is therefore an objective of the invention to provide an improved cost-efficient and less complex system for transferring storage containers between a delivery vehicle and an external conveyor.

### SUMMARY OF THE INVENTION

The present invention is set forth and characterized in the independent claims, while the dependent claims describe other characteristics of the invention

It is described a delivery vehicle for operation on a two-dimensional rail system with rails extending in a first direction and a second direction, wherein the second direction is perpendicular to the first direction, the delivery vehicle comprising:
a vehicle body;
two sets of wheels connected to the vehicle body for engagement with the underlying rail system and for moving the delivery vehicle in the first and second directions;
a container carrier for supporting a container from below, wherein the container carrier comprises a first conveyor;
a conveyor drive shaft for driving the first conveyor;
at least one drive coupling comprising a connection interface accessible from an outer side portion of the vehicle body, wherein the drive coupling is rotatably connected to a motor drive shaft such that when the motor drive shaft is rotated the drive coupling and the connection interface are rotated.

In this way, the delivery vehicle can drive a remote second conveyor via the drive coupling and an associated complementary connection interface. This reduces the overall cost of a conveyor system, because normally conveyors require specific equipment, such as a dedicated motor to be able to rotate the conveyor.

The delivery vehicle may further comprise a motor connected to the motor drive shaft, wherein the motor drive shaft is rotatably connected to the conveyor drive shaft.

The connection interface can be positioned within a recess on the delivery vehicle. In this way the connection interface may not protrude beyond the cross-sectional area of the delivery vehicle when looking in plan view of the delivery vehicle, such that two delivery vehicles each comprising a connection interface on passing sides can pass one another on adjacent tracks of a rail of the rail system without coming into contact with one another.

The complementary connection interface on the remote second conveyor may protrude from a remainder of the conveyor in order for its connection interface to engage the connection interface of the delivery vehicle within the recess.

It is further described an assembly of a delivery vehicle as described above coupled with a remote second conveyor, the connection interface of the delivery vehicle coupled with a complementary connection interface of the second conveyor to deliver torque from the delivery vehicle's drive coupling to a drive shaft of the second conveyor. The remote second conveyor's sole source of power may be from the torque supplied by the delivery vehicle via the coupled connection interfaces. In this way the remote conveyor may not require a power supply nor any electrical devices.

Preferably, the connection interface between the first and second conveyors preferably transmits rotational movement with a 1:1 ratio. In general, a 1:1 ratio for all types of connection interface may be advantageous in order to match the speeds of the first conveyor with the second conveyor.

It is further described a delivery vehicle for operation on a two-dimensional rail system with rails extending in a first direction and a second direction,
a container carrier for supporting a container from below, wherein the container carrier comprises a conveyor;
a conveyor drive shaft for rotating the conveyor;
at least one drive coupling comprising a connection interface accessible from on an outer side portion of the vehicle body, wherein the drive coupling is rotatably connected to a motor drive shaft such that when the motor drive shaft is rotated the drive coupling is rotated.

In other words, in this embodiment, the drive coupling and connection interface on at least one side of the vehicle body may serve as a torque or power output on at least one side of the vehicle body. This torque output is used to drive the external or remote second conveyors.

The vehicle body may comprise all necessary components in order to move the delivery vehicle, such as one or more motors for driving the wheels and for track shift switching between movement in the first direction and the second direction on the underlying rail system. In addition, the delivery vehicle may comprise one or more motors for driving the conveyor. Furthermore, the delivery vehicle may comprise means for communicating with a main control system, such that the main control system can instruct the delivery vehicle to move to specific parts of the grid as well as receiving information from the delivery vehicle.

The first conveyor may be arranged for horizontal movement of a container supported by the first conveyor.

The container carrier may comprise a conveyor arranged to convey the container on and off the container carrier in a horizontal direction.

The first conveyor can handle storage containers of different shapes and sizes, such as e.g. AutoStore bin and other boxes of the same size, or larger or smaller size than the standard Autostore bin.

The container may be a storage container, a KLT box, a packing box, etc. Thus, as used herein, the term “storage container or container” is related to any container suitable for holding one or more items. The “container” may be made of any material suitable for the purpose of holding at least one item, such as plastic, metal, wood, paper, etc.

A KLT box is an industrial stacking container conforming to the VDA 4500 standard. The most common sizes are 600 mm×400 mm and 400 mm×300 mm, meaning that these containers stacked upon each other will fill a Euro-pallet measuring 1200 mm×800 mm. These containers may be stacked and are manufactured typically in grey polypropylene or another thermoplastic by injection molding.

The delivery vehicles may comprise one or more sensors to detect that the storage container has moved far enough onto the first conveyor before the delivery vehicle can drive. The same sensor(s) or additional sensor(s) can be provided to detect whether the storage container has moved too far onto the first conveyor such that there is a risk the storage container might come off the opposite end of the first conveyor.

A rotational axis of the connection interface may be perpendicular to a rotational axis of the conveyor drive shaft. The rotational axis of the motor drive shaft and the connection interface may in the same plane.

The delivery vehicle may further comprise an angled transmission for transferring rotational motion about the motor drive shaft to rotational motion about the connection interface. Angled transmission may be a bevel gear transmission. Preferably, the bevel gear transmission is mitre gears. Mitre gears are a type of bevel gears that have equal numbers of teeth. The shafts are positioned at right angles from each other, and the gears have matching pitch surfaces and angles, with a conically shaped pitch surface.

Mitre gears may be useful for transmitting rotational motion at a 90 degrees angle with a 1:1 ratio.

The drive coupling of the delivery vehicle may comprise:
a first connection shaft parallel to the motor drive shaft,
a second connection shaft rotatably connected to the first connection shaft via the angled transmission, and wherein the connection interface may be connected on the second connection shaft.

The connection interface may comprise a cog-wheel mounted on the conveyor drive shaft (42) for transferring rotational movement from the first conveyor to an external cog-wheel connected to a second conveyor drive shaft (74) of a second conveyor. In order to ensure that the first and second conveyors rotate in the same direction an idler gear system connected to the external cog-wheel may be used.

The motor drive shaft and the conveyor drive shaft may be parallel.

The motor drive shaft and the conveyor drive shaft may have a common axis of rotation.

The delivery vehicle may comprise two connection interfaces, each of the connection interfaces being arranged on an opposite outer side portion of the vehicle body for operating second conveyors arranged on opposite ends of the delivery vehicle.

The connection interface may comprise an intermediate roller arranged parallel to the first conveyor, and which rotates together with the first conveyor. When the delivery vehicle is positioned next to a second conveyor, both the first conveyor and the second conveyor are in contact with the intermediate roller, and rotational movement is transferred from the first conveyor, via the intermediate roller, to the second conveyor. The intermediate roller ensures that the first and second conveyors rotate in the same direction.

The first conveyor and the intermediate roller can be mechanically linked or they may be in frictional contact. The intermediate roller and the second conveyor may, when the delivery vehicle is positioned next to the second conveyor be in frictional contact. The second conveyor then forms a complementary connection interface.

The first conveyor on the delivery vehicle may comprise a plurality of parallel oriented rolls having a common longitudinal direction perpendicular to one or more side walls. In this way the rolls allow one or more containers to be shifted into or off the first conveyor while being guided by the side walls. The first conveyor may comprise rolls with or without integrated motor(s) mounted between supports for respective ends of the rolls (such as parallel railings). The rolls allow the storage container to be moved onto or out of the first conveyor. In addition, the rolls provide support from below for the storage container while situated on the first conveyor of the delivery vehicle.

The first conveyor may be conveyor, rollers, belt, balls, rods, a chain drive or any similar means adapted for the easy moving of the storage container from the first conveyor to the second conveyor, or in a counter direction from the second conveyor to the first conveyor.

The simple setup of the second conveyor, i.e. not need for software nor power to operate the second conveyor, provides for modularity in terms of where to arrange the second conveyors around the periphery of the rail system.

It is further described a system for horizontal movement of storage containers between a first conveyor and a second conveyor, wherein the system comprises:
a two-dimensional rail system with rails extending in a first direction and a second direction, wherein the second direction is perpendicular to the first direction,
a delivery vehicle comprising a vehicle body and two sets of wheels connected to the vehicle body for engagement with the underlying rail system and for moving the delivery vehicle in the first and second directions, wherein the delivery vehicle comprises a first conveyor for supporting a storage container from below;
a second conveyor separate from the first conveyor;
a motor assembly for driving the first and/or second conveyor;
at least one drive coupling comprising a connection interface accessible from an outer side portion of the vehicle body for transferring rotational movement between the first conveyor and the second conveyor.

A connection interface of the second conveyor may comprise a complementary connection interface for engagement with the connection interface of the delivery vehicle such that when the first and second conveyors are in contact with each other a container can be transferred between the first and second conveyors.

The delivery vehicle may comprise the motor assembly for driving the first conveyor. The motor assembly comprises any necessary motors or gearing to rotate the first conveyor and the drive coupling (and the associated connection interface), such as a motor and a motor drive shaft and a belt or similar for rotating a conveyor drive shaft of the first conveyor.

In an aspect, the second conveyor is non-motorized.

In another aspect, the first conveyor is non-motorized and the motor assembly is connected to the second conveyor. The motor assembly is then arranged in connection with the second conveyor and may comprise necessary motors or gearing to rotate the second conveyor and complementary connection interface, such as a motor, a motor drive shaft and a belt or similar for rotating a conveyor drive shaft of the first conveyor.

In an aspect of the system, the delivery vehicle can be a delivery vehicle as described above.

The complementary connection interface may comprise an intermediate roller associated with the second conveyor, and which rotates together with the second conveyor, and wherein the intermediate roller is arranged such that, when the first conveyor on the delivery vehicle is in contact with the intermediate roller, rotational movement of the first conveyor is transferred to the second conveyor via the intermediate roller. The rotational movement is preferably transferred from the intermediate roller to the first conveyor by frictional contact.

When the delivery vehicle comes into contact with the external conveyor, it can lower itself down into contact with the intermediate roller connected to the external conveyor. This ensures a good contact and sufficient friction, and thus power, so that the rotational movement of the first conveyor on the delivery vehicle can be transferred to the rotational movement of the external second conveyor even with heavy boxes.

Furthermore, in addition, if the delivery vehicle is positioned directly above a grid cell/access opening, all of the wheels may be lowered to contact the rail system during movement of storage containers between the first and second conveyors. This will give a more stable delivery vehicle during the transfer of storage containers between the first and second conveyors.

In another aspect of the system, the connection interface and complementary connection interface comprise a cog-wheel associated with the first and second conveyors arranged such that when a cog-wheel associated with the first conveyor is in contact with a cog-wheel associated the second conveyor, rotational movement of the first conveyor is transferred to the second conveyor via the cog-wheels, or vice versa. The system may further comprise an idler gear system for ensuring that the first and second conveyors rotate in the same direction.

The connection interface can be positioned within a recess on the delivery vehicle such that the connection interface connects to a protruding torque output such as a complementary connection interface on an external second conveyor.

The motor driving the first conveyor may operate reversibly for moving the first conveyor (and any connected second conveyor, in two directions).

The second conveyor may be rollers, belt conveyor, balls, rods, a chain drive or any similar means adapted for the easy moving of the storage container between the first and second conveyors.

The second conveyor may form a stand-alone unit or it may be arranged side-by-side with other second conveyors forming larger units with two or more second conveyors.

The delivery vehicle is arranged for delivering/receiving the container to/from an external second conveyor. The second conveyor may be arranged for transport of the container between the first container and an access station or access point arranged on an opposite side of the second conveyor. In this example, the second conveyor and the access station may form one common conveyor or they may be separate conveyors mechanically linked to move together. In either case, the second conveyor and the access station move in tandem in the same direction, i.e. synchronously. The motor operating the first conveyor may have sufficient power to operate the first conveyor, the second conveyor and any conveyor of the access station.

An upper surface of the second conveyor is preferably at same height as an upper surface of the first conveyor that the container is carried on. This allows the container to easily enter or exit the second conveyor from the first conveyor.

The container may be transported on the rollers to/from the access station. That means that the drive motor drives the rollers for transporting the container to the access station, and after an item(s) in the container has been handled, the motor is reversed for moving the first and second conveyors, and thus the storage container, in the opposite direction, away from the access station and towards the first conveyor on the delivery vehicle.

The access station may comprise walls or enclosure panels arranged about a perimeter of the access station and at least a section of the second conveyor.

The delivery vehicle may be arranged to deliver a first container to the second conveyor and move to another second conveyor to receive a second container which has been handled at an access station.

In certain situations, if the delivery vehicle comprises openings in both opposite ends, the delivery vehicle can replace a standard conveyor in that the storage container can enter the delivery vehicle from one side, then the delivery vehicle can move a certain distance, before the storage container exits the delivery vehicle on the other side.

The second conveyor, i.e. the external conveyor, can be e.g.:
a picking station from which a human or robotic operator may pick on or more items from the storage container, or
it can form a buffer in a lower end of a port column such that storage containers can be lowered onto, or retrieved from, the second conveyor either by container handling vehicles operating in a plane above the second conveyor or by delivery vehicles with a first conveyor in the same plane as the second conveyor. Possibly, two or more storage containers can be placed on top of one another on the second conveyor.

The second conveyors may be arranged at different levels, where one or more lifts can be used to transfer delivery vehicles between the different levels. Such delivery vehicle lifts are known to the skilled person, for example as disclosed in document WO2019238639A1 (applicant: Autostore Technology AS), which content is incorporated herein.

It is further described a method of horizontal movement of storage containers between a first conveyor and a second conveyor in an automated storage and retrieval system, wherein the system comprises:
a two-dimensional rail system with rails extending in a first direction and a second direction, wherein the second direction is perpendicular to the first direction,
a delivery vehicle comprising a vehicle body and two sets of wheels connected to the vehicle body for engagement with the underlying rail system and for moving the delivery vehicle in the first and second directions, wherein the delivery vehicle comprises a first conveyor for supporting a storage container from below;
a second conveyor separate from the first conveyor;
a motor assembly for driving the first or second conveyor; wherein the method comprises the steps of:
instructing the delivery vehicle to enter a position next to the second conveyor such that a connection interface of the delivery vehicle is in contact with a complementary connection interface of the second conveyor which represents a position where an upper surface of the first conveyor is in the same plane or substantially in the same plane as an upper surface of the second conveyor, wherein the connection interface of the delivery vehicle is configured for engagement with the complementary connection interface of the second conveyor;
operating the motor assembly to drive the first or second conveyor, wherein rotational movement is transferred between the first and second conveyors, thereby moving the storage container between the upper surface of the first conveyor and the second conveyor.

In an aspect of the method, the motor assembly can be connected to the first conveyor of the delivery vehicle, such that, upon rotation of the first conveyor, the second conveyor is rotated via the connection interface and the complementary connection interface.

The motor assembly may be connected to the second conveyor, such that, upon rotation of the second conveyor, the first conveyor is rotated via the connection interface and the complementary connection interface.

The following drawings are appended to facilitate the understanding of the invention. The drawings show embodiments of the invention, which will now be described by way of example only, where:

### BRIEF DESCRIPTION OF THE DRAWINGS

FIG. 1A is a perspective view of a framework structure of a prior art automated storage and retrieval system;

FIGS. 1B-D is a top view of a container handling vehicle rail system, where FIG. 1B shows a single rail system, FIG. 1C shows a double rail system and FIG. 1D shows a double rail system with the width and length of a container handling vehicle grid cell indicated

FIG. 2 is a perspective view of a prior art container handling vehicle having a centrally arranged cavity for carrying storage containers therein;

FIG. 3A is a perspective view of a prior art container handling vehicle having a cantilever for carrying storage containers underneath;

FIGS. 3B and 3C are perspective views of a prior art automated storage and retrieval system, where FIG. 3B shows a part of the system having a delivery rail system with container delivery vehicles operating below the rail system of container handling vehicles and FIG. 3C shows an example of a container delivery vehicle having a storage container stored within;

FIGS. 3D and 3E are perspective views of another prior art remotely operated delivery vehicle having a container carrier provided with conveyors;

FIGS. 3F and 3G show an exemplary wheel base unit for the delivery vehicle;

FIGS. 4A-C show different perspective views of a delivery vehicle in a first embodiment with a connection interface for connection to an external second conveyor, where FIGS. 4A and 4B show a delivery vehicle with a container carrier and first conveyor, and FIG. 4C a view with where the first conveyor has been removed to better illustrate a possible setup of a drive coupling for transferring rotational movement from a motor drive shaft to a connection interface on the vehicle body,

FIGS. 5A-5C show examples of an external non-motorized second conveyor to be driven by the drive coupling of the delivery vehicle, and in particular: in FIG. 5A the second conveyor has been removed, in FIG. 5B it is shown a cross section along the centre of the second conveyor in the moving direction of the second conveyor and the mechanical connection comprising mitre gears and rods to transfer the rotational movement from the delivery vehicle to rotational movement of the second conveyor, and in FIG. 5C an opposite view where the connection facilitating movement of the second conveyor using a belt connecting a rotational axis of the second conveyor with the mitre gears and rods for transferring the rotational movement between the delivery vehicle and the second conveyor;

FIG. 6A shows an example of a delivery vehicle with a connection interface on one side of the vehicle body, wherein the connection interface is in the form of an intermediate roller arranged parallel to the first conveyor, and which rotates together with the first conveyor;

FIG. 6B shows an example of a delivery vehicle with a connection interface on one side of the vehicle body, and a second conveyor with a complementary connection interface in the form of an intermediate roller, and which rotates together with the second conveyor;

FIG. 7A shows an example of a delivery vehicle with a connection interface on two sides of the vehicle body, and a second conveyor with a complementary connection interface in the form of an intermediate roller, and which rotates together with the second conveyor, and where the delivery vehicle and the second conveyor are arranged separate from each other;

FIG. 7B is a similar view as FIG. 7A, however in FIG. 7B the delivery vehicle and the second conveyor are arranged adjacent each other in a position where rotational movement can be transferred between the first conveyor and the second conveyor;

FIG. 8A is a side view of a delivery vehicle carrying a storage container, where the delivery vehicle has a connection interface in the form of a cog-wheel on one side of the vehicle body, and a second conveyor with a complementary connection interface in the form of an external cog-wheel, where the delivery vehicle and the second conveyor are arranged in contact with each other;

FIG. 8B is a top view of FIG. 8A;

FIG. 9A is a side view of a delivery vehicle, where the delivery vehicle has a connection interface in the form of a cog-wheel on two sides of the vehicle body, and a second conveyor carrying a storage container, the second conveyor having a complementary connection interface in the form of an external cog-wheel, where the delivery vehicle and the second conveyor are arranged separate from each other;

FIG. 9B is a top view of FIG. 9A;

FIGS. 10A and 10B are perspective views from opposite sides of a system comprising a storage and retrieval system with a rail system where container handling vehicles for lifting storage containers from below operates, a delivery rail system with delivery vehicles and second conveyors arranged at a lower elevation than the rail system where the container handling vehicles operate, and a multi-level delivery rail system in three levels with delivery vehicles and second conveyors arranged on the different levels;

### DETAILED DESCRIPTION OF THE INVENTION

In the following, embodiments of the invention will be discussed in more detail by way of example only and with reference to the appended drawings. It should be understood, however, that the drawings are not intended to limit the invention to the subject-matter depicted in the drawings.

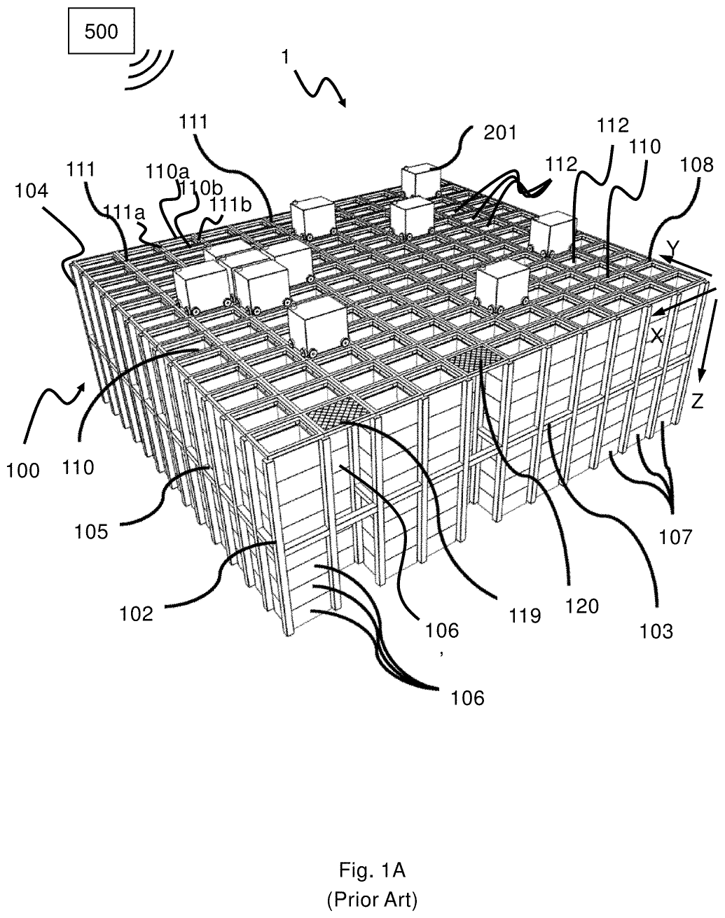

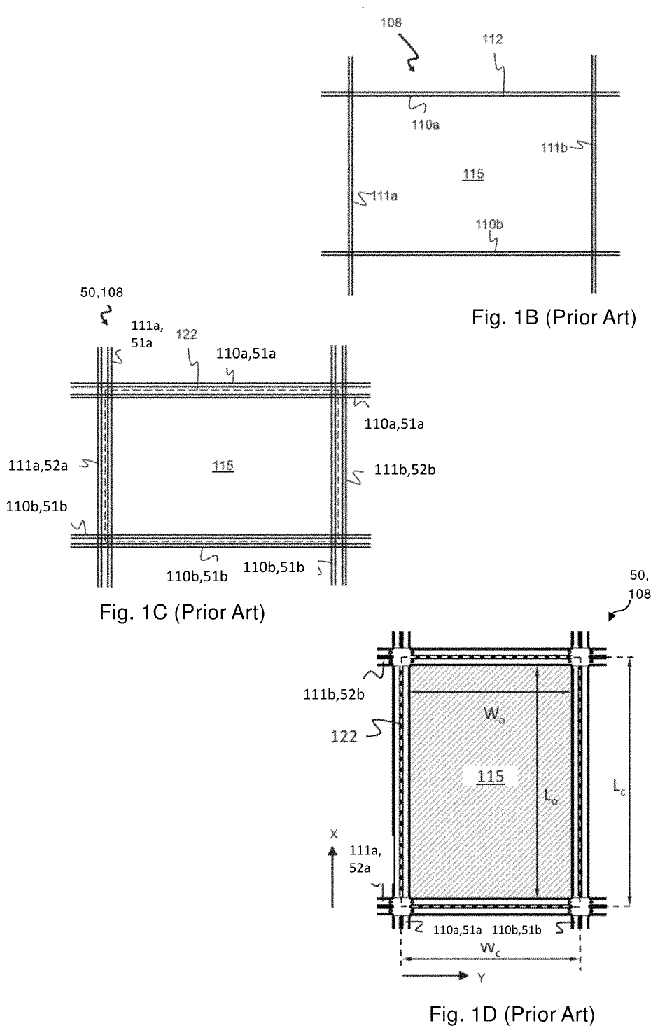

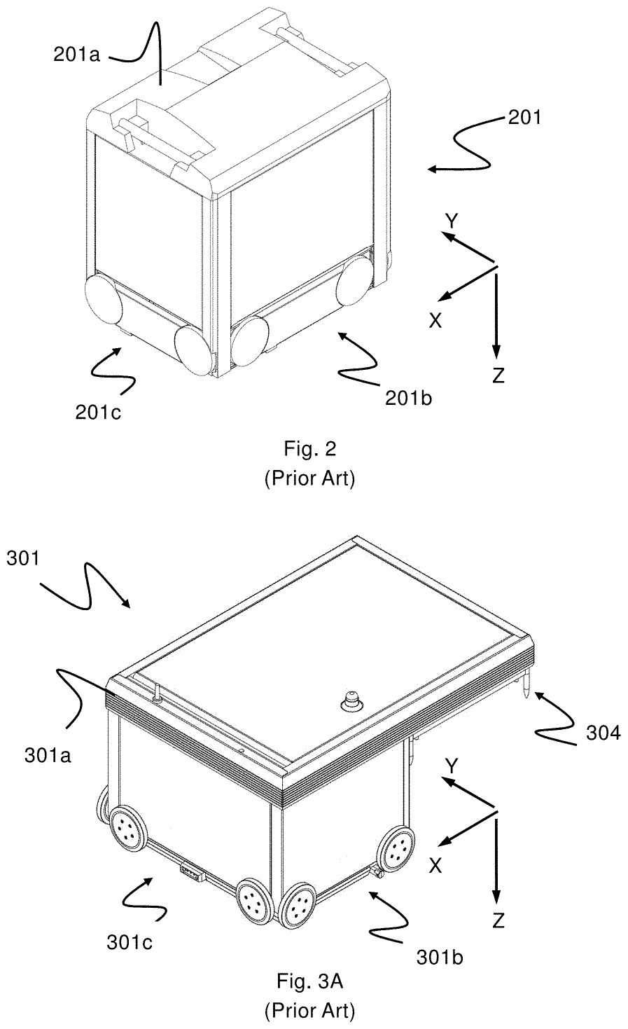

The framework structure 100 of the automated storage and retrieval system 1 is constructed in accordance with the prior art framework structure 100 described above in connection with FIGS. 1-3, i.e. a number of upright members 102 and a number of horizontal members 103, which are supported by the upright members 102, and further that the framework structure 100 comprises a first, upper rail system 108 in the X direction and Y direction.

The framework structure 100 further comprises storage compartments in the form of storage columns 105 provided between the members 102, 103, where storage containers 106 are stackable in stacks 107 within the storage columns 105.

The framework structure 100 can be of any size. In particular it is understood that the framework structure can be considerably wider and/or longer and/or deeper than disclosed in FIG. 1A. For example, the framework structure 100 may have a horizontal extent of more than 700×700 columns and a storage depth of more than twelve containers.

The rail system 108 may be a single rail (also denoted single track) system, as is shown in FIG. 1B. Alternatively, the rail system 108 may be a double rail (also denoted double track) system, as is shown in FIG. 1C, thus allowing a container handling vehicle 201 having a footprint generally corresponding to the lateral area defined by an access opening/grid column 112 to travel along a row of grid columns even if another container handling vehicle 201 is positioned above a grid column neighboring that row. Both the single and double rail system, or a combination comprising a single and double rail arrangement in a single rail system 108, forms a grid pattern in the horizontal plane P comprising a plurality of rectangular and uniform grid locations or grid cells 122, where each grid cell 122 comprises a grid opening 115 being delimited by a pair of rails 110a,110b of the first rails 110 and a pair of rails 111a,111b of the second set of rails 111. In FIG. 1C the grid cell 122 is indicated by a dashed box. For example, the sections of the rail-based system being made of aluminium are the rails, and on the upper surface of the rails, there are a pair of tracks that the wheels of the vehicle run in. However, the sections could be separate rails each with a track.

Consequently, rails 110a and 110b form pairs of rails defining parallel rows of grid cells running in the X direction, and rails 111a and 111b form pairs of rails defining parallel rows of grid cells running in the Y direction. Similarly, on a delivery rail system 308, rails 310a and 310b form pairs of rails defining parallel rows of grid cells running in the X direction, and rails 311a and 311b form pairs of rails defining parallel rows of grid cells running in the Y direction.

As shown in FIG. 1D, each grid cell 122 has a width W_{c} which is typically within the interval of 30 to 150 cm, and a length L_{c} which is typically within the interval of 50 to 200 cm. Each grid opening 115 has a width Wₒ and a length Lₒ which is typically 2 to 10 cm less than the width W_{c} and the length L_{c} of the grid cell 122.

In the X and Y directions, neighboring grid cells are arranged in contact with each other such that there is no space therebetween.

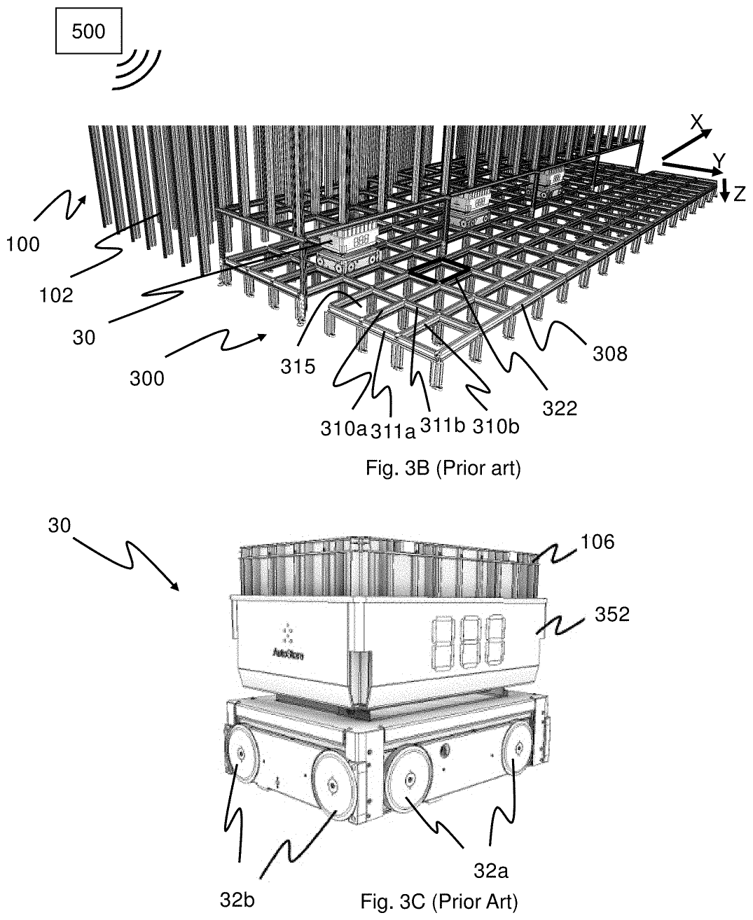

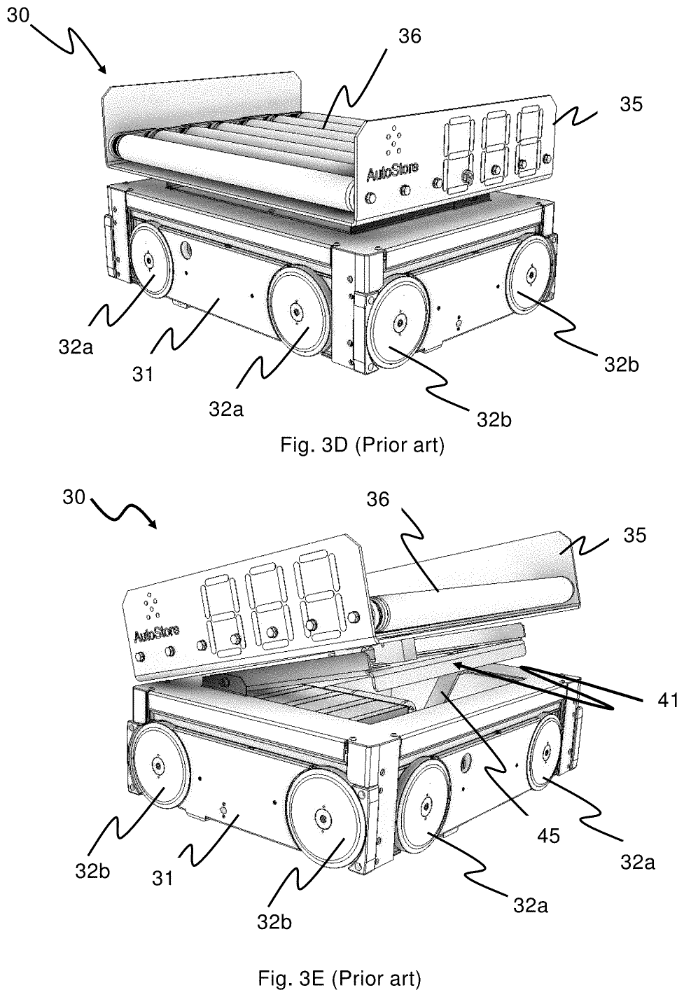

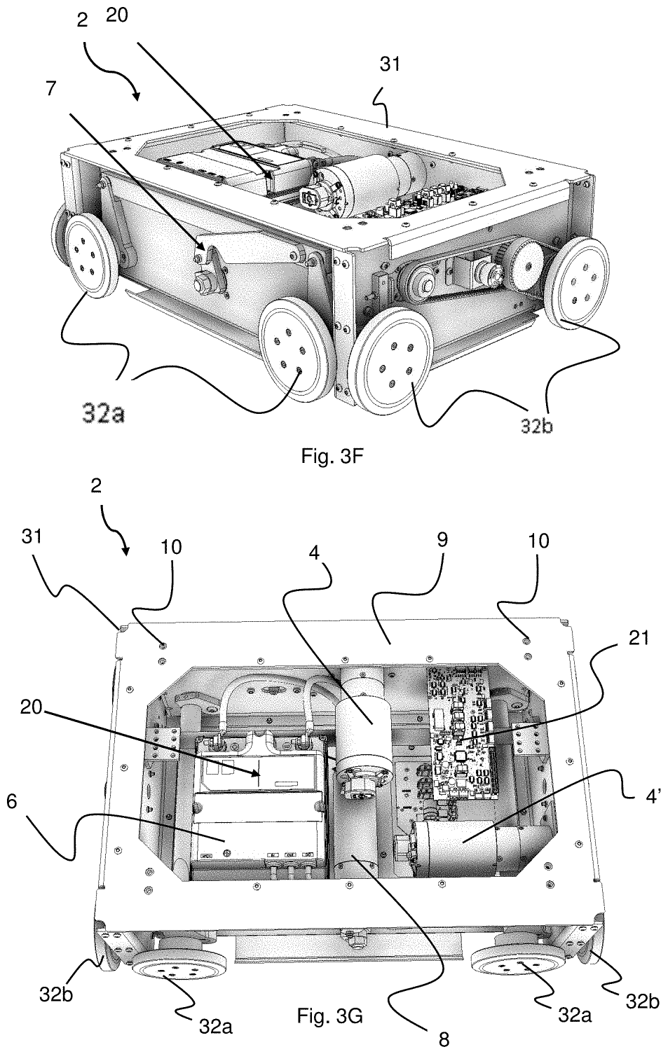

FIG. 3A is a perspective view of a prior art container handling vehicle 301 having a cantilever for carrying storage containers underneath.

A different automated storage and retrieval system 1 is shown in part in FIG. 3B. The upright members 102 constitute part of a framework structure 100 onto which a transport rail system 108 with a plurality of container handling vehicles 201,301 are operating.

Below this transport rail system 108, near the floor level, another framework structure 300 is shown which partly extends below some of the storage columns 105 of the framework structure 100. As for the other framework structure 100, a plurality of vehicles 30 may operate on a rail system 308 comprising a first set of parallel rails 310 directed in a first direction X and a second set of parallel rails 311 directed in a second direction Y perpendicular to the first direction X, thereby forming a grid pattern in the horizontal plane P_{L} comprising a plurality of rectangular and uniform grid locations or grid cells 322. Each grid cell of this lower rail system 308 comprises a grid opening 315 being delimited by a pair of neighboring rails 310a,310b of the first set of rails 310 and a pair of neighboring rails 311a,311b of the second set of rails 311.

The part of the lower rail system 308 that extends below the storage columns 105 are aligned such that its grid cells 322 are in the horizontal plane P_{L} coincident with the grid cells 122 of the upper rail system 108 in the horizontal plane P.

Hence, with this particular alignment of the two rail systems 108,308, a storage container 106 being lowered down into a storage column 105 by a container handling vehicle 250 can be received by a prior art delivery vehicle 30 configured to run on the rail system 308 and to receive storage containers 106 down from the storage column 105. In other words, the delivery vehicle 30 is configured to receive storage containers 106 from above, preferably directly from the container handling vehicle 201,301.

FIG. 3C shows an example of such a prior art delivery vehicle 30 comprising a wheel assembly 32a, 32b similar to the wheel assembly 251 described for the prior art container handling vehicle 250 and a storage container support 352 for receiving and supporting a storage container 106 delivered by an above container handling vehicle 201,301.

After having received a storage container 106, the delivery vehicle 30 may drive to a port or access station adjacent to the rail system 308 (not shown) for delivery of the storage container 106 for further handling and shipping.

Referring to FIGS. 3D and 3E, it is shown perspective views another prior art remotely operated delivery vehicle having a container carrier 35 provided with a conveyor 36 arranged to convey the container 106 on and off the container carrier 35 in a horizontal direction. In this configuration, the container carrier 35 comprises a base plate, a conveyor 36 arranged on the base plate and two parallel side walls protruding upwards from the base plate. The rolling devices 32a,32b and the vehicle body 31 are equal or similar to the rolling device 32 and the vehicle body 31 described in relation to FIG. 3F and FIG. 3G below.

The conveyor 36 may be set up by, inter alia, a plurality of parallel oriented rolls 36 having a common longitudinal direction perpendicular to the two side walls. In this way the rolls 36 allow one or more storage containers 106 to be shifted onto or off the container carrier 35 while being guided by the side walls. The conveyor may be connected to a conveyor motor allowing rotation of one or more of the rolls.

Alternatively, the side walls are omitted, allowing the storage containers 106 to have a horizontal offset relative to a vertical center plane oriented perpendicular to the rolls longitudinal direction. Hence, the storage containers 106 may be arranged such that it extends beyond the end of the rolls in the rolls longitudinal direction.

In yet another alternative configuration, the conveyor may comprise a plurality of rolling balls within or on the base plate of the container carrier 35 allowing the one or more storage containers 106 to roll on top of the balls. With this configuration, and with no side walls present, the storage container 106 may be moved in any direction above the base plate.

As is seen in FIG. 3E, the container carrier 35 may be tilted by means of a dedicated displacement device 41. The tilting may be around a pivot axis directed in the principal moving direction of the delivery vehicle 30. If the delivery vehicle 30 is moving on perpendicular rails (see below), these principal directions would be in either the X direction or the Y direction.

The tilting of the displacement device 41 may for example be obtained by a lifting arm 45 coupled to the vehicle body 31 and the container carrier 35. Further, the lifting arm 45 may be driven by a dedicated tilt motor (not shown) or the rolling device motor or both.

An exemplary wheel base unit for the delivery vehicle 30 is shown in FIGS. 3F and 3G. The wheel base unit 2 features a wheel arrangement 32a,32b having a first set of wheels 32a for movement in a first direction upon a rail system (i.e. any of the top rail system 108 and the delivery rail system 308) and a second set of wheels 32b for movement in a second direction perpendicular to the first direction. Each set of wheels comprises two pairs of wheels arranged on opposite sides of the wheel base unit 2. To change the direction in which the wheel base unit may travel upon the rail system, one of the sets of wheels 32b is connected to a wheel displacement assembly 7. The wheel displacement assembly is able to lift and lower the connected set of wheels 32b relative to the other set of wheels 32a such that only the set of wheels travelling in a desired direction is in contact with the rail system. The wheel displacement assembly 7 is driven by an electric motor 8. Further, two electric motors 4,4′, powered by a rechargeable battery 6, are connected to the set of wheels 32a,32b to move the wheel base unit in the desired direction.

Further referring to FIGS. 3F and 3G, the horizontal periphery of the wheel base unit 2 is dimensioned to fit within the horizontal area defined by a grid cell, such that two wheel base units may pass each other on any adjacent grid cells of the rail system 108, 308. In other words, the wheel base unit 2 may have a footprint, i.e. an extent in the X and Y directions, which is generally equal to the horizontal area of a grid cell, i.e. the extent of a grid cell in the X and Y directions, e.g. as is described in WO2015/193278A1, the contents of which are incorporated herein by reference.

The wheel base unit 2 has a top panel/flange 9 (i.e. an upper surface) configured as a connecting interface for connection to a connecting interface of a first conveyor. The top panel 9 have a centre opening 20 and features multiple through-holes 10 (i.e. connecting elements) suitable for a bolt connection via corresponding through-holes in the first conveyor 36. In other embodiments, the connecting elements of the top panel 9 may for instance be threaded pins for interaction with the through-holes of the first conveyor. The presence of a centre opening 20 is advantageous as it provides access to internal components of the wheel base unit, such as the rechargeable battery 6 and an electronic control system 21.

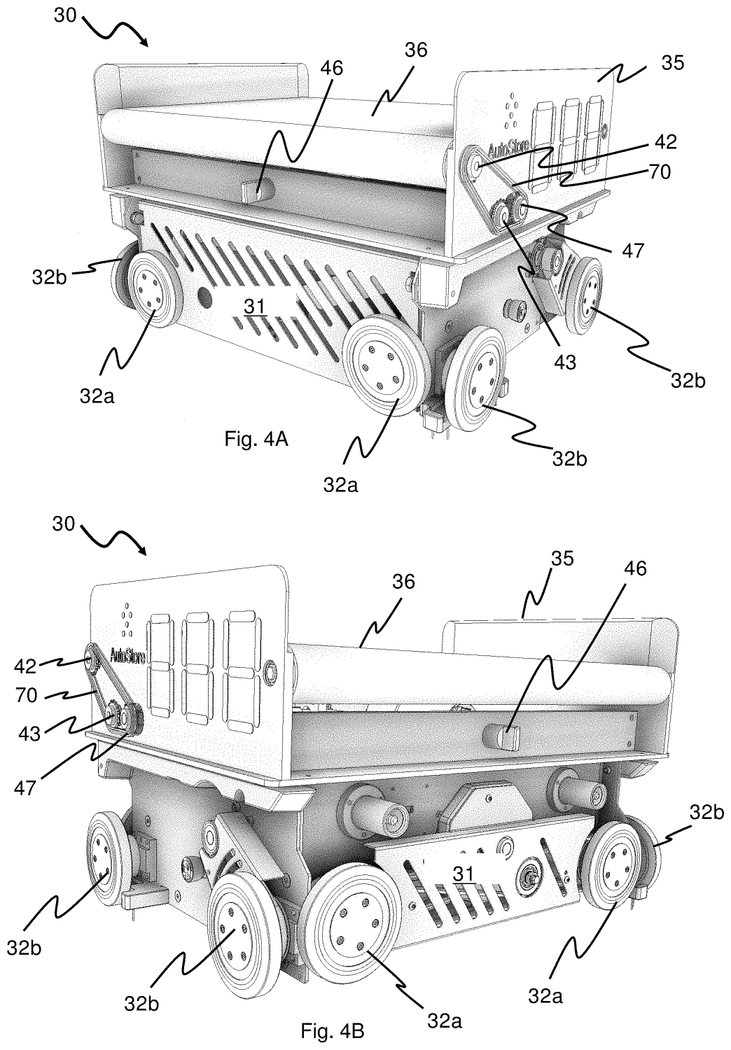

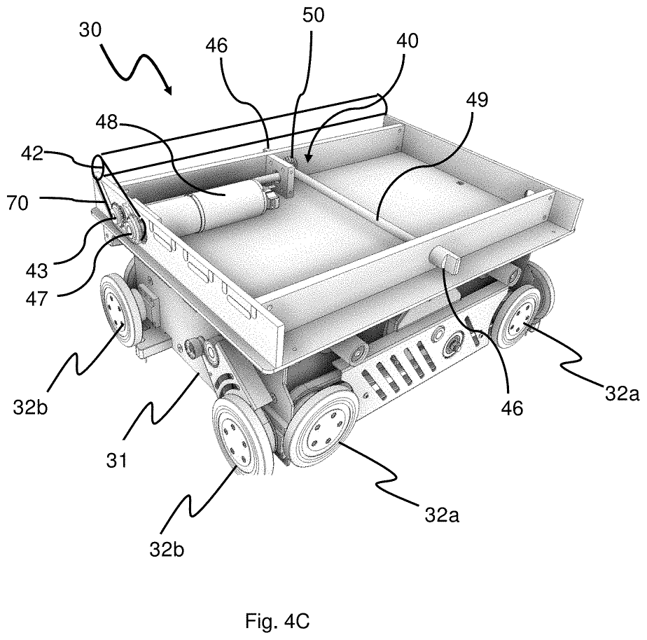

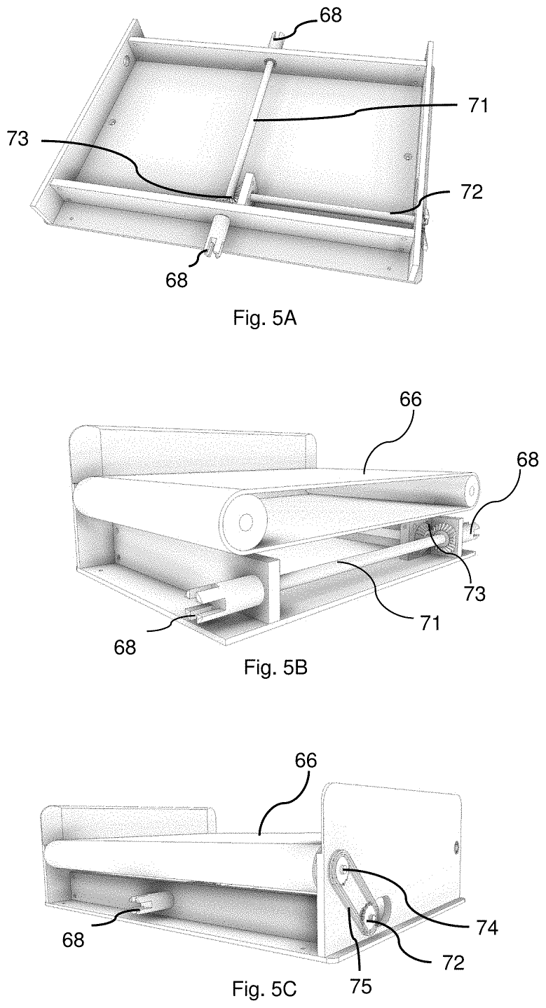

FIGS. 4A-4C show different perspective views of a delivery vehicle 30 in a first embodiment with a connection interface 46 for connection to an external second conveyor (see e.g. FIGS. 5A-5C), where FIGS. 4A and 4B show a delivery vehicle 30 with a container carrier 35 and first conveyor 36, and FIG. 4C a view with where the first conveyor has been removed to better illustrate a possible setup of a drive coupling 40 for transferring rotational movement from a motor drive shaft 47 (which is connected to a motor 48) to a connection interface 46 on the vehicle body 31. The delivery vehicle 30 comprising two sets of wheels 32a,32b connected to the vehicle body 31 for engagement with an underlying rail system (not shown) and for moving the delivery vehicle 30 in the first and second directions X, Y. The rolling devices 32a,32b and the vehicle body 31 are similar to the rolling devices 32a,32b and the vehicle body 31 described in relation to FIGS. 3F and 3G above. The delivery vehicle 30 is suitable for operation on a two-dimensional rail system with rails extending in a first direction X and a second direction Y, where the second direction is perpendicular to the first direction. The delivery vehicle 30 further comprising a container carrier 35 with a first conveyor 36 for supporting a storage container (not shown) from below. A conveyor drive shaft 42 for rotating the first conveyor 36 is arranged parallel to a motor drive shaft 47. The conveyor drive shaft 42 and the motor drive shaft 47 are rotationally coupled via a flexible force transferring means (e.g. a drive belt) 70, which may be arranged on an outside of the vehicle body 31 as shown. Alternatively, the flexible force transferring means could be arranged at a centre of the roll if the conveyor belt was provided as a twin belt arrangement on the roller. In the embodiment of FIGS. 4A-4C, the drive coupling 40 comprises a first connection shaft 43 parallel to the motor drive shaft 47 and a second connection shaft 49 perpendicular to the first connection shaft 43. The second connection shaft 49 is rotatably connected to the first connection shaft 43 via an angled transmission 50, wherein the connection interface 46 is connected in both ends of the second connection shaft 49. The connection interfaces 46 are accessible from an outer side portion of the vehicle body 31 and are disclosed as a screw coupling. The setup enables that the drive coupling 40, and thus the connection interface(s) 46, is rotatably connected to the motor drive shaft 47 such that when the motor drive shaft 47 is rotated, the drive coupling 40 and the connection interface(s) 46 are rotated. When the connection interface 46 is in connection with a complementary connection interface 68 on an external second conveyor 66 (see FIGS. 5A-5C) this setup enables that rotation can be transferred to rotational movement of the second conveyor 66 at the same speed as the first conveyor 36 for transferring storage containers 106 between the first conveyor 36 and the second conveyor 66 as well as between the second conveyor 66 and the first conveyor 36.

FIGS. 5A-5C show examples of an external non-motorized second conveyor 66 to be driven by the drive coupling 40 and connection interface 46 of the delivery vehicle 30 in FIGS. 4A-4C. In FIG. 5A the second conveyor 66 has been removed, in FIG. 5B it is shown a cross section along the centre of the second conveyor 66 in the moving direction of the second conveyor 66 as well as the mechanical connection comprising mitre gears and connection shafts to transfer the rotational movement from the delivery vehicle 30 to rotational movement of the second conveyor 66, and in FIG. 5C an opposite view where the connection facilitating movement of the second conveyor 66 using a belt connecting a rotational axis of the second conveyor with the mitre gears and connection shafts for transferring the rotational movement between the delivery vehicle 30 and the second conveyor 66.

In the illustrated embodiment there are two complementary connection interface(s) 68 in the form of a toothed sprocket which can cooperate with the connection interface 46 in the form of a flat plate on the delivery vehicle 30 (see e.g. FIGS. 4A-4C) such that they can couple torque from the delivery vehicle to the remote/external second conveyor. The complementary connection interfaces 68 are connected in each end of a first shaft 71.

While two complementary connection interface(s) 68 are shown at opposite ends of the first shaft 71, the non-motorised second conveyor may comprise only a single connection interface 68.

The connection interface(s) 68 may comprise a toothed sprocket as shown, comprising a set of axially extending teeth which can mesh with a corresponding formation of the connection interface 46 on the delivery vehicle 30, or it could comprise other shapes that are capable of transmitting torque from the connection interface 46 on the delivery vehicle 30 to the first shaft 71 of the non-motorised second conveyor 66. For example, the connection interfaces 46, 68 could comprise complimentary cogs with radially or generally radially extending splines, protrusion and socket arrangements (e.g., a hexagonal or other shaped protrusion having axially extending corner edges or teeth that engage with a splined or profiled recess), or other similar connection to provide a mechanical torque connection.

In some embodiments, the second connection shaft 49 and the associated connection interfaces 46 could be arranged with an axis parallel to but displaced from the first shaft 71, so that circumferential surfaces of the connection interfaces 46, 68 engage with one another to transmit torque from the delivery vehicle 30 to the non-motorised second conveyor. For example, the connection interfaces could be in the form of cogs or splined shafts.

The connection interfaces 46, 68 could also comprise a frictional coupling, for example, through friction pads arranged to couple torque from one end of one shaft to an end of the other, e.g., when the delivery vehicle 30 urges itself against a connection interface 68 of the non-motorised second conveyor under drive provided by a set of the delivery vehicles' wheels 32a,32b. The friction pads, in comparison to the connection interfaces 46,68 described above, may be in the form of flat discs or have planar engagement portions which are flat in a radial plane perpendicular to the shaft axis. Additional assistance could be provided to the torque coupling using electromagnetic clamps or suction devices which help to clamp the friction pads together during transmission of the torque.

The first shaft 71 is connected to one end of a perpendicularly arranged second shaft 72, where rotational movement between the first and second shafts 71,72 is provided via mitre gears 73. An opposite end of the second shaft 72 may extend beyond the width of the second conveyor 66. The second shaft 72 is parallel to a second conveyor drive shaft 74. The opposite end of the second shaft 72 is rotationally connected to the second conveyor drive shaft 74 via a flexible force transferring means (e.g. drive belt) 75.

Although it is disclosed in FIGS. 4A-4C and 5A-5C that the motor 48 and motor drive shaft 47 are arranged as part of the delivery vehicle 30, it is clear that the motor 48 and drive shaft 47 can be arranged in the connection with the second conveyor 66 such that rotational movement can be transferred from the complementary connection interface 68 on the second conveyor 66 to the connection interface 46 on the delivery vehicle instead.

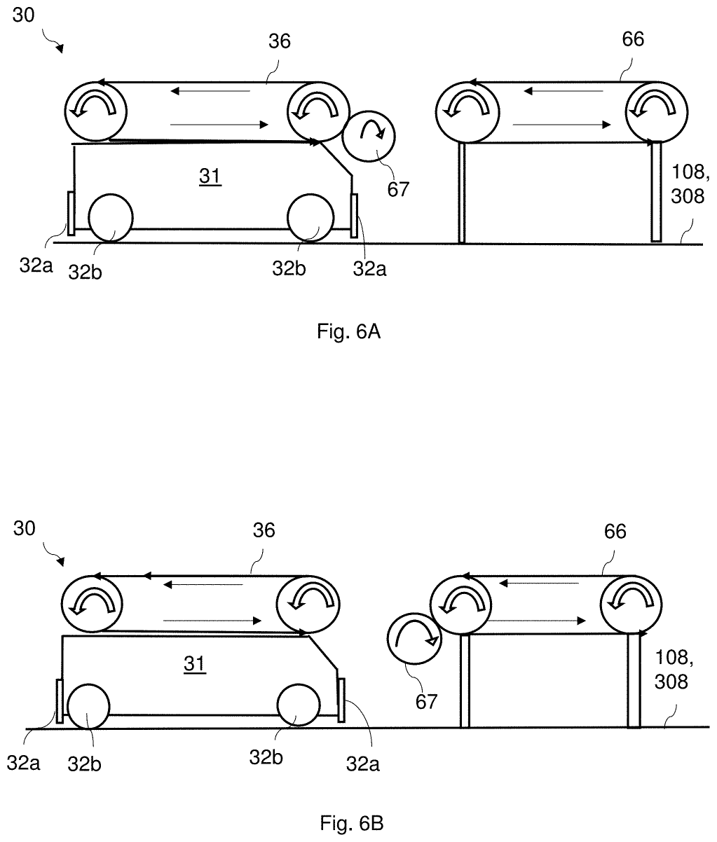

FIG. 6A shows an example of a delivery vehicle 30 with a connection interface on one side of the vehicle body 31, wherein the connection interface is in the form of an intermediate roller 67 arranged parallel to the first conveyor 36. The intermediate roller 67 rotates together with the first conveyor 36. The intermediate roller 67 is thus connected to the first conveyor 36 and rotation can be achieved by either friction between the surface of the first conveyor 36 and the intermediate roller 67 or by a mechanical connection such as a belt running between a conveyor drive shaft and a rotary shaft of the intermediate roller 67 (not shown). When the delivery vehicle 31 has positioned itself next to the second conveyor 66, rotational movement is transferred from the first conveyor 36 via the intermediate roller 67 and to the second conveyor 66. The surface of the intermediate roller 67 and the surface of the second conveyor 66 are frictionally connected such that the transfer of the rotational movement is achieved. In order to provide sufficient friction between the surfaces of the intermediate roller 67 and the second conveyor 66, preferably all wheels in both sets of wheels 32a,32b are in contact with the underlying rail system 108,308 thereby ensuring a stable transfer of the storage containers between the first and second conveyors 36,66 with reduced risk that the delivery vehicle 30 unintentionally moves.

FIG. 6B shows an example of a delivery vehicle 30 with a connection interface on one side of the vehicle body 31, and a second conveyor 66 with a complementary connection interface in the form of an intermediate roller 67. The intermediate roller 67 is connected to the second conveyor 66 and rotates together with the second conveyor 66 and rotation can be achieved by either friction between the surface of the first conveyor 36 and the intermediate roller 67 or by a mechanical connection such as a belt running between a second conveyor drive shaft and a rotary shaft of the intermediate roller 67 (not shown). When the delivery vehicle 31 has positioned itself next to the second conveyor 66, rotational movement is transferred from the second conveyor 36 via the intermediate roller 67 and to the first conveyor 66. The surface of the intermediate roller 67 and the surface of the first conveyor 66 are frictionally connected such that the transfer of the rotational movement is achieved. In order to provide sufficient friction between the surfaces of the intermediate roller 67 and the first conveyor 66, the delivery vehicle 31 can lower itself onto the intermediate roller 67. Furthermore, preferably all wheels in both sets of wheels 32a,32b are in contact with the underlying rail system 108,308 thereby ensuring a stable transfer of the storage containers between the first and second conveyors 36,66 with reduced risk that the delivery vehicle 30 unintentionally moves.

The vehicle body 31 may comprise a recess 69 for accommodating the intermediate roller 67, regardless whether the intermediate roller 67 is connected to the first conveyor 36 or the second conveyor 66.

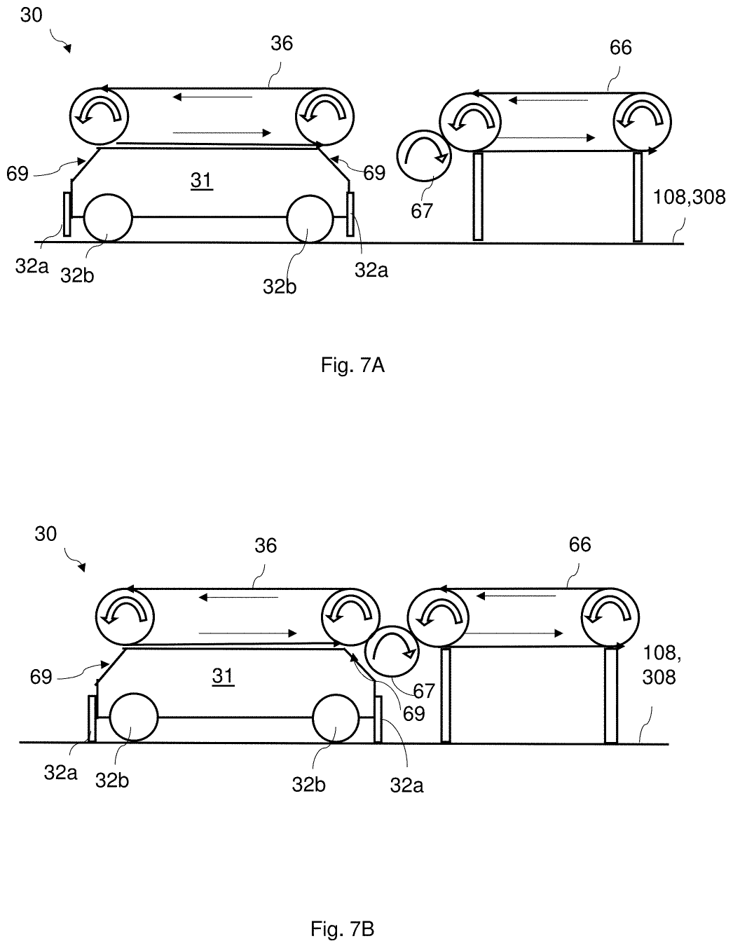

FIG. 7A shows an example of a delivery vehicle 30 with a connection interface on two sides of the vehicle body 31, and a second conveyor 66 with a complementary connection interface in the form of an intermediate roller 67. The remaining features are similar to the embodiment described with reference to FIG. 6B and will not be repeated herein.

FIG. 7B is a similar view as FIG. 7A, however in FIG. 7B the delivery vehicle 31 and the second conveyor 66 are arranged adjacent each other in a position where rotational movement can be transferred between the first conveyor 36 and the second conveyor 66. In order to provide sufficient friction between the surfaces of the intermediate roller 67 and the first conveyor 66, the delivery vehicle 31 can lower itself onto the intermediate roller 67. Furthermore, preferably all wheels in both sets of wheels 32a,32b are in contact with the underlying rail system 108,308 thereby ensuring a stable transfer of the storage containers between the first and second conveyors 36,66 with reduced risk that the delivery vehicle 30 unintentionally moves.

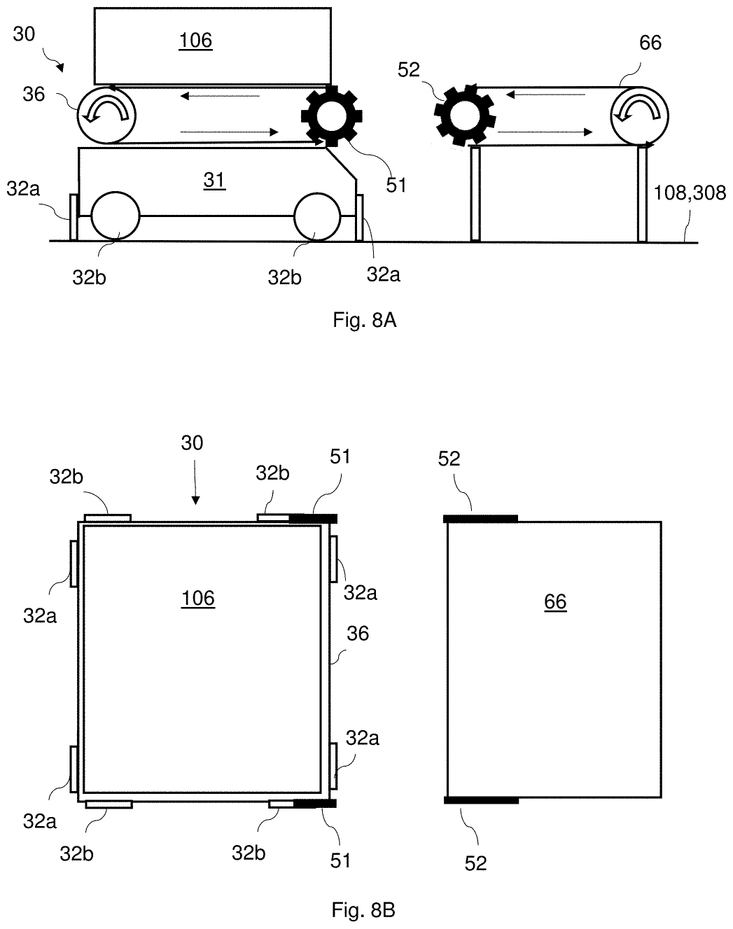

FIG. 8A is a side view of a delivery vehicle 30 carrying a storage container 106, where the delivery vehicle 30 has a connection interface in the form of a cog-wheel 51 on one side of the vehicle body 31. The second conveyor 36 has a complementary connection interface in the form of an external cog-wheel 52. In FIG. 8A the delivery vehicle 30 and the second conveyor 66 are arranged in contact with each other. As disclosed in the Figure, the cog-wheel 51 is arranged at the end of the first conveyor 36, e.g., mounted on the drive shaft 42 of the first conveyor to engage with the external cog-wheel 52 of the second conveyor 66. A drive gear (not shown) can be mounted on the second conveyor drive shaft 74 to transfer the rotational movement. An idler gear or similar may be arranged to reverse the rotation such that the first and second conveyors 36, 66 rotate in the same direction.

FIG. 8B is a top view of FIG. 8A showing two cog-wheels 51 arranged on opposite ends of the conveyor drive shaft 42 to cooperate with two external cog-wheels 52 on opposite ends of the second conveyor 66 to transfer rotational movement between the first cog-wheels 51 and the external cog-wheels 52. This setup enables that when a cog-wheel 51 of the first conveyor 36 is in contact with a cog-wheel 52 of the second conveyor 66, rotational movement of the first conveyor 36 is transferred to the second conveyor 66 via the cog-wheels 51,52, or vice versa. As such, storage containers 106 can be transferred between the first conveyor 36 and the second conveyor 66 as well as between the second conveyor 66 and the first conveyor 36.

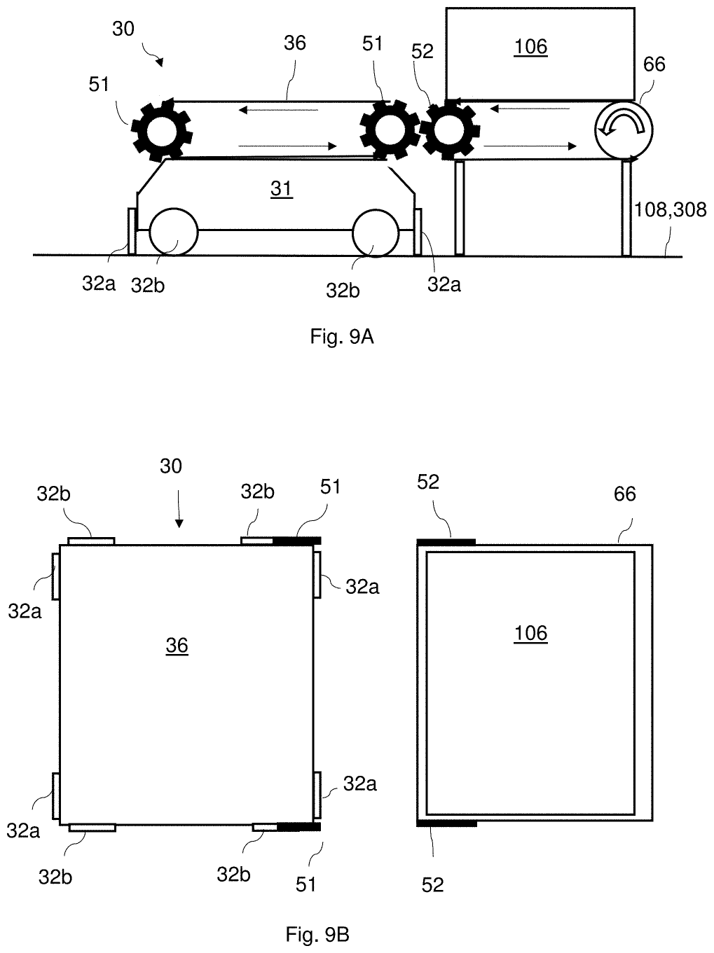

FIG. 9A is a side view of a delivery vehicle 30, where the delivery vehicle 30 has a connection interface in the form of a cog-wheel 51 on two sides of the vehicle body 31 (i.e. on both ends of the first conveyor 36) and a second conveyor 66 carrying a storage container 106. This setup enables the possibility that the delivery vehicle 31 can connect to external cog-wheels 52 on both ends of the delivery vehicle 31. Furthermore, if arranging a number of delivery vehicles 31 with this particular configuration with the conveyors 36 one after the other, a continuous conveyor may extend all the way from the delivery vehicle 31 at one end to a delivery vehicle 31 or second conveyor 66 at an opposite end. In the disclosed example, the second conveyor 66 has a complementary connection interface in the form of an external cog-wheel 52. The delivery vehicle 30 and the second conveyor 66 are connected to each other. When the delivery vehicle 30 is positioned next to the second conveyor 66, preferably all wheels in both sets of wheels 32a,32b are in contact with the underlying rail system 108,308 thereby ensuring a stable transfer of the storage containers between the first and second conveyors 36,66 with reduced risk that the delivery vehicle 30 unintentionally moves.

FIG. 9B is a top view of FIG. 9A.

In one embodiment the connection interfaces 44 do not protrude beyond the footprint of the wheel base unit 2. The delivery vehicles 30 may then pass each other on adjacent tracks (i.e. double tracks), without the connection interfaces 44 engaging one another or without the connection interfaces 44 colliding with adjacent delivery vehicles 30. Conceivably, if the connection interfaces 44 did protrude to some extent they could be arranged at different heights on opposite sides of the delivery vehicle 30 and grooves could be provided to allow the connection interfaces 44 to sweep past without contact.

Alternatively, if the second conveyor 66 is non-motorized, the connection interface 44 may protrude in order to engage the connection interface 44 of the delivery vehicle 30. However, depending on the positioning of the second conveyor 66 with respect to the ail system 108,308, that might require a direct on approach towards the second conveyor 66 by the delivery vehicle 30 so that the connection interfaces 44,46,47,68 engage properly, and that may mean that the grid cell 122 in front of it can only be used in one direction of travel towards and away from the second conveyor 66. Alternatively, the second conveyor 66 could be stepped back a distance, e.g., a few centimeters or so, so that its connection interface 68 does not protrude into the neighboring grid cell, in which case, the delivery vehicle 30 would need to move a similar distance into the grid cell with the second conveyor 66 (so that the connection interfaces can be engaged and torque transmitted from one to the other).

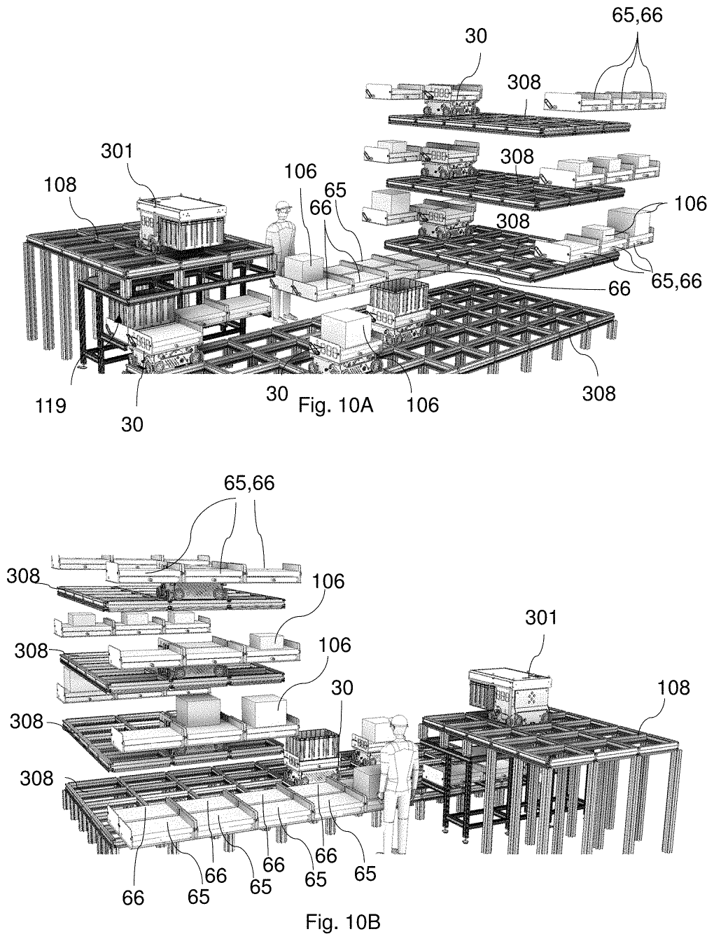

FIGS. 10A and 10B are perspective views from opposite sides of a system where a delivery vehicle 30 according to the invention can be used. The system comprising a storage and retrieval system with a rail system where container handling vehicles 301 for lifting storage containers 106 from below operates. A delivery rail system 308 with delivery vehicles 30 and second conveyors 66 are arranged at a lower elevation than the rail system where the container handling vehicles 301 operate. A multi-level delivery rail system 308 in three levels are disclosed with delivery vehicles 30 and second conveyors 66 arranged on the different levels. The delivery vehicles 30 can pick up storage containers 106 from a buffer in a lower end of a port column 119. The storage containers 106 can be transferred into the buffer by being lowered onto, or retrieved from, the second conveyor 66 either by container handling vehicles 301 operating on the rail system 108 in a plane above the second conveyor 66 or by delivery vehicles with a first conveyor 36 in the same plane as the second conveyor 66. Possibly, two or more storage containers 106 can be placed on top of one another on the second conveyor 66.

It is further disclosed several access stations 65 or picking station arranged adjacent a second conveyor 66 from which a human or robotic operator may pick one or more items from the storage container 106. In order to increase safety for the operator, the second conveyor 66 may be of sufficient length such that the operator's distance from the rail system 308 is sufficient to perform safe handling of the items in the storage containers 106 or boxes.

The delivery vehicles 30, with or without storage container(s) 106 or box(es), can move between the different levels of the delivery rail system 308 using a dedicated delivery vehicle lift (not shown).

If using delivery vehicles 30 with an external torque or power output, i.e. a connection interface 46 which can cooperate with a complementary connection interface 68 on the second conveyor 66, provides for modularity in terms of where to arrange the second conveyors 66 as there is not need for software nor power to operate the second conveyor 66 and the second conveyors 66 can be easily re-arranged to other locations dependent on the pending requirements.

In the preceding description, various aspects of the delivery vehicle and the automated storage and retrieval system according to the invention have been described with reference to the illustrative embodiment. For purposes of explanation, specific numbers, systems and configurations were set forth in order to provide a thorough understanding of the system and its workings. However, this description is not intended to be construed in a limiting sense. Various modifications and variations of the illustrative embodiment, as well as other embodiments of the system, which are apparent to persons skilled in the art to which the disclosed subject matter pertains, are deemed to lie within the scope of the present invention.

List of reference numbers

| | |
|---|---|
| 1 | Prior art storage and retrieval system |
| 2 | Wheel base unit |
| 3 | Container supporting unit |
| 4, 4′ | Electric motor |
| 6 | Rechargeable battery |
| 7 | Wheel displacement assembly |
| 8 | Electric motor for wheel displacement assembly |
| 9 | Top panel/flange |
| 10 | Through-holes |
| 20 | Centre opening |
| 21 | Electronic control system |
| 30 | Delivery vehicle |
| 31 | Vehicle body |
| 32a, 32b | Wheel arrangement, first and second set of wheels |
| 35 | Container carrier |
| 36 | First conveyor |
| 40 | Drive coupling |
| 41 | Displacement device/Tilting device |
| 42 | Conveyor drive shaft |
| 43 | First connection shaft |
| 44 | Connection interface |
| 45 | Lifting arm |
| 46 | Connection interface (first and second) |
| 47 | Motor drive shaft |
| 48 | Motor |
| 49 | Second connection shaft |
| 50 | Angled transmission |
| 51 | Cog wheel |
| 52 | External cog wheel (in connection with second |
| | conveyor) |
| 65 | Access station |
| 66 | Second conveyor/external conveyor/Conveyor line |
| 67 | Intermediate roller |
| 68 | Complementary connection interface |
| 69 | Recess in vehicle body |
| 70 | Flexible force transferring means/Drive belt of |
| | first conveyor |
| 71 | First shaft |
| 72 | Second shaft |
| 73 | Mitre gears |
| 74 | Second conveyor drive shaft |
| 75 | Flexible force transferring means/Drive belt of |
| | second conveyor |
| 100 | Framework structure |
| 102 | Upright members of framework structure |
| 103 | Horizontal members of framework structure |
| 104 | Storage grid |
| 105 | Storage column |
| 106 | Storage container |
| 106′ | Particular position of storage container |
| 107 | Stack |
| 108 | Rail system |
| 110, 110a, 110b | Parallel rails in first direction (X) |
| 111, 111a, 111b | Parallel rail in second direction (Y) |
| 112 | Access opening |
| 115 | Grid opening |
| 119 | First port column |
| 120 | Second port column |
| 122 | Grid cell |
| 201 | Prior art storage container vehicle |
| 201a | Vehicle body of the storage container vehicle 201 |
| 201b | Drive means/wheel arrangement, first direction (X) |
| 201c | Drive means/wheel arrangement, second direction (Y) |
| 300 | Delivery framework structure |
| 301 | Prior art cantilever storage container vehicle |
| 301a | Vehicle body of the storage container vehicle 301 |
| 301b | Drive means in first direction (X) |
| 301c | Drive means in second direction (Y) |
| 308 | Delivery rail system |
| 310, 310a, 310b | First set of parallel rails in first direction (X) |
| | on delivery rail system |
| 311, 311a, 311b | Second set of parallel rails in second direction (Y) |
| | on delivery rail system |
| 315 | Grid opening in delivery rail system |
| 322 | Grid cell of delivery rail system |
| 352 | Storage container support |
| 500 | Control system |
| X | First direction |
| Y | Second direction |
| Z | Third direction |

1. A delivery vehicle for operation on a two-dimensional rail system with rails extending in a first direction and a second direction, wherein the second direction is perpendicular to the first direction, the delivery vehicle comprising:
a vehicle body;
two sets of wheels connected to the vehicle body for engagement with the underlying rail system and for moving the delivery vehicle in the first and second directions;
a container carrier for supporting a container from below, wherein the container carrier comprises a first conveyor;
a conveyor drive shaft for driving the first conveyor; and
at least one drive coupling comprising a connection interface accessible from an outer side portion of the vehicle body, wherein the drive coupling is rotatably connected to a motor drive shaft such that when the motor drive shaft is rotated the drive coupling and the connection interface are rotated.

2. The delivery vehicle according to claim 1, further comprising a motor connected to the motor drive shaft, wherein the motor drive shaft is rotatably connected to the conveyor drive shaft.

3. The delivery vehicle according to claim 1, wherein a rotational axis of the connection interface is perpendicular to a rotational axis of the conveyor drive shaft.

4. The delivery vehicle according to claim 2, wherein the drive coupling comprises an angled transmission for transferring rotational motion about the motor drive shaft to rotational motion about the connection interface.

5. The delivery vehicle according to claim 4, wherein the drive coupling comprises:
a first connection shaft parallel to the motor drive shaft, and
a second connection shaft rotatably connected to the first connection shaft via the angled transmission, and wherein the connection interface is connected on the second connection shaft.

6. The delivery vehicle according to claim 1, wherein the connection interface comprises a cog-wheel mounted on the conveyor drive shaft for transferring rotational movement from the first conveyor to an external cog-wheel connected to a second conveyor drive shaft of a second conveyor.

7. The delivery vehicle according to claim 1, wherein the motor drive shaft and the conveyor drive shaft are parallel.

8. The delivery vehicle according to claim 1, wherein the motor drive shaft and the conveyor drive shaft have a common axis of rotation.

9. The delivery vehicle according to claim 1, comprising two connection interfaces, each of the connection interfaces being arranged on an opposite outer side portion of the vehicle body.

10. The delivery vehicle according to claim 1, wherein the connection interface comprises an intermediate roller arranged parallel to the first conveyor, and which rotates together with the first conveyor.

11. The delivery vehicle according to claim 10, wherein the first conveyor and the intermediate roller are in frictional contact.

12. A system for horizontal movement of storage containers between a first conveyor and a second conveyor, wherein the system comprises:
a two-dimensional rail system with rails extending in a first direction and a second direction, wherein the second direction is perpendicular to the first direction,
a delivery vehicle comprising a vehicle body and two sets of wheels connected to the vehicle body for engagement with the underlying rail system and for moving the delivery vehicle in the first and second directions, wherein the delivery vehicle comprises a first conveyor for supporting a storage container from below;
a second conveyor separate from the first conveyor;
a motor assembly for driving the first and/or second conveyor; and
at least one drive coupling comprising a connection interface accessible from an outer side portion of the vehicle body for transferring rotational movement between the first conveyor and the second conveyor.

13. The system according to claim 12, wherein a connection interface of the second conveyor comprises a complementary connection interface for engagement with the connection interface of the delivery vehicle.

14. The system according to claim 12, wherein delivery vehicle comprises the motor assembly for driving the first conveyor.

15. The system according to claim 14, wherein the second conveyor is non-motorized.

16. The system according to claim 12, wherein the first conveyor is non-motorized and the motor assembly is connected to the second conveyor.

17. The system according to claim 12, wherein the delivery vehicle is a delivery vehicle for operation on a two-dimensional rail system with rails extending in a first direction and a second direction, wherein the second direction is perpendicular to the first direction, the delivery vehicle comprising:
a vehicle body;
two sets of wheels connected to the vehicle body for engagement with the underlying rail system and for moving the delivery vehicle in the first and second directions;
a container carrier for supporting a container from below, wherein the container carrier comprises a first conveyor;
a conveyor drive shaft for driving the first conveyor; and
at least one drive coupling comprising a connection interface accessible from an outer side portion of the vehicle body, wherein the drive coupling is rotatably connected to a motor drive shaft such that when the motor drive shaft is rotated the drive coupling and the connection interface are rotated.

18. The system according to claim 12, wherein the complementary connection interface comprises an intermediate roller associated with the second conveyor, and which rotates together with the second conveyor, and wherein the intermediate roller is arranged such that, when the first conveyor on the delivery vehicle is in contact with the intermediate roller, rotational movement of the first conveyor is transferred to the second conveyor via the intermediate roller.

19. The system according to claim 12, wherein the connection interface and complementary connection interface comprise a cog-wheel associated with the first and second conveyors and arranged such that when a cog-wheel associated with the first conveyor is in contact with a cog-wheel of the second conveyor, rotational movement of the first conveyor is transferred to the second conveyor via the cog-wheels, or vice versa.

20. A method of horizontal movement of storage containers between a first conveyor and a second conveyor in an automated storage and retrieval system, wherein the system comprises:
a two-dimensional rail system with rails extending in a first direction and a second direction, wherein the second direction is perpendicular to the first direction,
a delivery vehicle comprising a vehicle body and two sets of wheels connected to the vehicle body for engagement with the underlying rail system and for moving the delivery vehicle in the first and second directions, wherein the delivery vehicle comprises a first conveyor for supporting a storage container from below;
a second conveyor separate from the first conveyor;
a motor assembly for driving the first or second conveyor; wherein the method comprises the steps of:
instructing the delivery vehicle to enter a position next to the second conveyor (66) such that a connection interface of the delivery vehicle is in contact with a complementary connection interface of the second conveyor which represent a position where an upper surface of the first conveyor is in the same plane or substantially in the same plane as an upper surface of the second conveyor, wherein the connection interface of the delivery vehicle is configured for engagement with the complementary connection interface of the second conveyor;
operating the motor assembly to drive the first or second conveyor, wherein rotational movement is transferred between the first and second conveyors, thereby moving the storage container between the upper surface of the first conveyor and the second conveyor.

21. The method according to claim 20, wherein the motor assembly is connected to the first conveyor of the delivery vehicle, such that, upon rotation of the first conveyor, the second conveyor is rotated via the connection interface and the complementary connection interface.

22. The method according to claim 20, wherein the motor assembly is connected to the second conveyor, such that, upon rotation of the second conveyor, the first conveyor is rotated via the connection interface and the complementary connection interface.
